(19) United States
(12) Patent Application Publication
(10) Pub. No.: US 2013/0209806 A1
(43) Pub. Date: Aug. 15, 2013

(54) Coated Particles of a Glumatic Acid N,N-Diacetate Chelating Agent

(71) Applicants: Cornelis Elizabeth Johannus Van Lare, Wijchen (NL); Martin Heus, Arnhem (NL)

(72) Inventors: Cornelis Elizabeth Johannus Van Lare, Wijchen (NL); Martin Heus, Arnhem (NL)

(73) Assignee: AKZO NOBEL CHEMICALS INTERNATIONAL B.V., Amersfoort (NL)

(21) Appl. No.: 13/703,828

(22) PCT Filed: Jun. 27, 2011
(86) PCT No.: PCT/EP11/60672

§ 371 Date: Jan. 16, 2013

Related U.S. Application Data
(60) Provisional application No. 61/359,572, filed on Jun. 29, 2010.

(30) Foreign Application Priority Data
Jun. 28, 2010 (EP) 10167518.9

(51) Int. Cl. C11D 17/00

(52) U.S. Cl. CPC C11D 17/0039
USPC 428/404; 507/90; 507/241; 507/230; 507/211; 510/533; 510/441; 252/194; 252/180; 252/181; 428/403; 427/212; 524/239; 524/55

(57) ABSTRACT

The present invention relates to a coated particle containing a particle and a coating, wherein the particle contains glutamic acid N,N-diacetic acid or a partial salt thereof of the formula HnYm-GLDA, wherein Y is a cation, selected from the group of sodium, potassium and mixtures thereof, n+m=4, and wherein the coating contains at least one salt that contains as a cation at least one of sodium, potassium or lithium and as anion at least one of silicate sulfate, carbonate, chloride, nitrate, percarbonate, glycolate, oxalate, citrate, stearate, lactate, succinate, malonate, maleate, diglycolate, and fumarate, to a process to prepare such a particle, and, to the use thereof.

The invention relates to particles of (salts of) glutamic acid N,N-diacetic acid, a chelating agent of the formula COOH—CH(—CH₂—CH₂—COOH)—N—(CH₂—COOH)₂, abbreviated as GLDA, which are coated, to processes to produce said particles, and to the use of such particles.

The detergent market is currently undergoing important changes. Due to ecological and regulatory reasons the use of phosphate in high concentrations in detergent formulations is to be banned altogether or must at least be greatly reduced. The formulators of detergent products have to find alternatives to replace the phosphate compounds, with the most promising replacements being biodegradable chelating agents such as GLDA. Such chelating agents are used in a concentration from 5% to 60%. Many detergent formulations contain (co-)builders, which are typically polymers, such as e.g. polyacrylates, phosphonates, phosphates, silicates or zeolites. These co-builders are present in formulations in a concentration from 1% to 50%.

In powder or tabs detergent formulations, solid raw materials are required by the formulator. In for example automatic dishwashing (ADW) applications, the raw materials have to be in granule form to improve the tabletting and solids handling of the formulation. These granules typically have a size comprised between 300 and 2,000 microns. The usual form in which glutamic acid N,N-diacetic acid (GLDA) and its salts are available is a liquid with an active content from 35% to 50%. After drying, the substance (i.e. the powder or granules), especially when obtained in the amorphous state, shows hygroscopic properties to some extent, which makes it difficult to use it for the ADW formulators. Moreover, the granules obtained from a granulation process (such as fluid bed granulation) are somewhat brittle and thus cannot grow easily to the required size, resulting in slow processing and lots of fines. In addition, whether in powder or granule form, the (amorphous) chelating agent GLDA exhibits hygroscopic properties, and this will render the material sticky and thus introduce storage, handling, and manufacturing problems. Flow properties of particles are critical in many ways. During manufacture of the particles themselves, they must flow smoothly relative to one another, e.g. in a fluid bed. Additionally, they must then be successfully transported to storage and transport containers. Finally, they must again be transported from storage and fed into a powder or tablet manufacturing facility. Flow problems arise due to several causes. For chelating agents, poor flow can be due to low glass transition temperatures, tackiness, wetness, and physical entanglement of multifaceted, irregularly shaped particles.

GLDA will move into the ADW market and likely into many other fields where a strong, green chelate is needed. The term “green” here denotes materials with a high renewable carbon content, a sustainable environmentally friendly production process and/or a positive biodegradability assessment. While the state of the art builders used in detergent formulations, such as sodium tripolyphosphate (STPP) and nitrilo triacetic acid (NTA), do not require a co-granulation or coating process, the hygroscopic, dusty, and sticky properties of solid GLDA will make co-granulation or coating highly desirable.

It may be noted that documents like WO 2006/002954, WO 2006/003434, and GB 2415695 describe particles of other chelating agents than GLDA, such as of a methylglycine N,N-diacetic acid (MGDA) matrix encapsulated with polymeric materials such as polyethylene glycol and polyvinyl-pyrrolidone. However, not only do these documents not relate to coated particles of GLDA, also no disclosure or suggestion is made of coating the chelating agent with other coating materials. Additionally, unless very high levels of coating material are used, matrix encapsulation at best gives a partial coating layer but is known not to result in a closed coating layer.

Plain mixtures of chelating agent and additives are known in the art. Such mixtures are disclosed for example in EP 884 381, which document discloses a mixture of GLDA, an anionic surfactant, a salt of a polymer comprising carboxylic acid units and a crystalline aluminosilicate in specific proportions. EP 1803801 discloses a mixture of GLDA with at least one polyethylene glycol, a nonionic surfactant, polyvinyl alcohol, polyvinyl pyrrolidone, polyalkylene glycols or derivatives thereof. However, mixing the chelating agent and the other additives will hardly have any beneficial effect in reducing the hygroscopic behaviour of the chelating agent.

The object of the invention is to provide stable coated particles of GLDA of which the hygroscopic properties are improved, but more importantly GLDA is obtained in a free-flowing form so that it can be added to dry compositions and formulations that are in a powdery form. Another object of the present invention is to provide a process to make coated particles of GLDA wherein a closed layer of coating is obtained while avoiding the use of very high levels of coating material. In addition, the invention aims to provide stable coated particles of GLDA that are relatively cheap to prepare not only because the ingredients are not too expensive but also because the preparation process is relatively straightforward.

It should be noted that hygroscopicity comprises two different elements, namely a time dependent element and an amount dependent element, so a hygroscopicity improvement may be both a delay in the speed/rate with which water is taken up by a material as well as a reduction of the amount of water that will be taken up by a material.

It has now been found that when a salt from the group of sodium, potassium or lithium sulfate, carbonate, chloride, nitrate, percarbonate, glycolate, oxalate, citrate, stearate, lactate, succinate, malonate, maleate, diglycolate, fumarate is used as a coating, a coated particle of GLDA is acquired that has a high level of functional compounds and of which the hygroscopic and flow properties are acceptable without loss of strength of the particle, while the process to make it is quite simple and cheap.

The present invention now provides coated particles containing a particle and a coating, wherein the particle contains glutamic acid N,N-diacetic acid or a partial salt thereof of the formula HnYm-GLDA, wherein Y is a cation, that is sodium, potassium or a mixture thereof, n+m=4, and the coating comprises at least one salt that contains as a cation at least one of sodium, potassium or lithium and as anion at least one of silicate, sulfate, carbonate, chloride, nitrate, percarbonate, glycolate, oxalate, citrate, stearate, lactate, succinate, malonate, maleate, diglycolate, fumarate.

The invention further provides a process to make the above coated particles containing a particle and a coating, wherein the particle contains glutamic acid N,N-diacetic acid or a partial salt thereof of the formula HnYm-GLDA, wherein Y is a cation, that is sodium, potassium or a mixture thereof, n+m=4, and the coating comprises at least one salt that contains as a cation at least one of sodium, potassium or lithium and as anion at least one of silicate, sulfate, carbonate, chloride, nitrate, percarbonate, glycolate, oxalate, citrate, stearate, lactate, succinate, malonate, maleate, diglycolate, and fumarate, comprising the step of applying the coating on the particles to give a coating layer.

Finally, the invention provides the use of the coated particles in detergents, agriculture, in oil field applications, or in water treatment. Preferably, the particles are used in institutional and industrial cleaning compositions or household cleaning compositions, especially such cleaning compositions in powdery form.

The coating surrounding the GLDA chelating agent is such that it will act to sufficiently delay the chelating agent from absorbing moisture, thereby reducing the rate of particles sticking together or forming a solid mass, and hence preserving the free flowing properties. At the same time the coating layer is sufficiently readily water-soluble to release the chelating agent sufficiently rapidly in a final application wherein this is desired. Consequently, the invention provides an excellent balance between the barrier properties and the dissolution properties of the active ingredient GLDA. Further, the particle once formulated will provide a stable particle size that will not change during storage or transportation. Further, the chelating agent in the (structured) particles can be protected from the effects of UV rays, moisture, and oxygen. Chemical reactions between incompatible species of particles can be prevented due to the coating and the particles exhibit greatly improved storage, handling, and manufacturing properties.

Using the readily available and cheap salts of the invention it has been found possible to make coated particles of GLDA that have a high amount of ingredients that are functional in many applications, like in cleaning, while at the same time the costs can be kept as low as possible and a good water barrier is created. Quite unexpectedly an already relatively low amount of salt (i.e. an amount of between 10 and 30 wt %) gave a significant water barrier. At the same time, adding a salt coating layer to a particle containing GLDA chelating agent proved to increase the strength of the GLDA particle, unlike many polymers used in the prior art that swell upon contact with water and in the swollen state will easily give a strength reduction of the granule. Finally, the coated particles of the invention have a favourable ratio of ingredients that are active in their intended use to total ingredients.

The term “coated particles” as used throughout this application is meant to denote all particles (e.g. powder or granules) containing GLDA (“the particle”) which have been encapsulated, coated, matrix coated, or matrix encapsulated, with at least one other material (“the coating”), as a consequence of which the particles have other physical characteristics than the chelating agent without this coating. Coated particles, unlike plain mixtures, have more coating material on the outer side of the coated particle and more core material on the inner side of the coated particle. Preferably the coating is a closed layer as established by scanning electron microscopy/EDX, which is always the case if the coating is used in an amount of at least about 30 wt % when a matrix encapsulation process is used and, if the process is a fluidized bed encapsulation process, when at least 5 wt % of coating mixture is applied on the basis of the total particle. The particles can for instance have a modified colour, shape, volume, apparent density, reactivity, durability, pressure sensitivity, heat sensitivity, and photosensitivity compared to the original chelating agent. To be more specific, the coating layer serves to improve the storage stability of the granule and to preserve flowability. This is achieved as the coating layer reduces or delays the absorption of water of the core, i.e. reduces the overall hygroscopicity.

Preferably, in the process to prepare coated particles in accordance with the invention, the GLDA-containing particle is in substantially dry form, with “substantially dry” meaning that the GLDA-containing particle has a water content of below 10 wt %, preferably of below 6 wt %, on the basis of (total) solids.

Coated particles of GLDA of the invention may take several different forms depending on the processing conditions and the choice of materials.

Referring to the Figures, they provide an illustration of several particles as further described below.

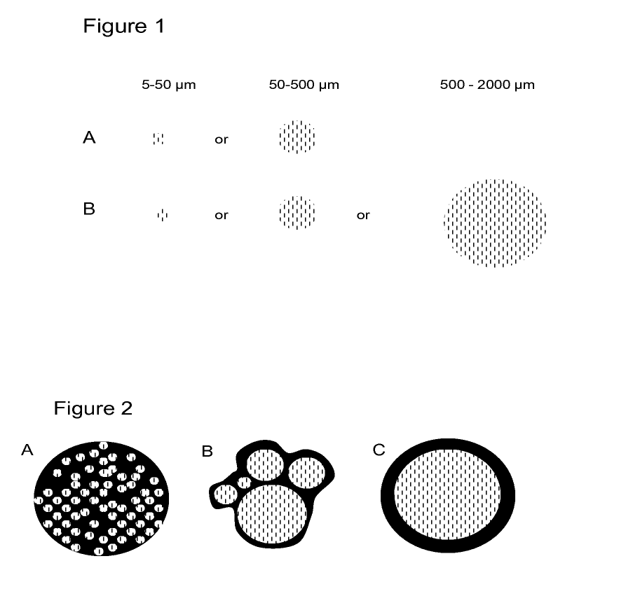

FIGS. 1A-B depict state of the art particles that are not coated.

FIG. 1A depicts schematically two different median particle sizes for a dried chelating agent. For example, 5-50 μm particles can be made (e.g. by spray drying) or 50-500 μm particles can be made (e.g. by fluid bed agglomeration).

FIG. 1B depicts schematically that when a structuring agent is used to provide more robust granules, the maximum size of the granules created (e.g. by fluid bed granulation) can be increased to 3,000 μm.

FIGS. 2A-C depict coated particles of this invention.

FIG. 2A depicts the particles of this invention, where small (5-50 μm) particles are coated in a continuous matrix of coating polymer and the matrix encapsulation coating is acquired by spray drying with a high amount of coating polymer.

FIG. 2B depicts a particle of this invention in which a set of larger chelating agent granules (or structured chelating agent granules) are coated with a thin layer of coating polymer.

FIG. 2C e.g. depicts the coating of a large-structured granule in which an exterior polymer coating is created around an inner structured core.

In a preferred embodiment of the invention, when making a cross-section of the coated particles they contain more than 50% of core material in the inner 50% (on the basis of diameter) of the cross-section (which is roughly the case in the particle of FIG. 2A), more preferably more than 80% (which is roughly the case in the particle of FIG. 2B), and most preferably more than 90% (which is the case in FIG. 2C).

It is known to those skilled in the art that the application of the coating material controls the particle design as e.g. shown in FIG. 2, and that thus the method to apply the coating material can lead to different particles. Each particle can exhibit the improved qualities of the current invention and will exhibit a number of different advantages. For instance, the particle depicted schematically by FIG. 2C will, due to the large particle size, need the lowest amount of coating to achieve a closed layer of coating material. This particle, however, may require the use of a structuring agent to provide a robust inner structured particle. However, in cases where little structuring material is desired, a particle more similar to FIG. 2A may be created.

This invention also covers the use of the coated particles in detergents, agriculture, in oil field applications, in water treatment, and other applications that require or benefit from the multiple benefits provided by this invention, i.e. the dissolution of crystals/scale, the sequestration of metal ions which can otherwise lead to precipitation, and the inhibition of scale growth. One preferred embodiment of this invention is the use of the coated particles in automatic dishwashing. Another preferred embodiment of this invention is the use of the particles in subterranean oil and gas treatment and exploration, well completion, and production operations.

In a preferred embodiment the at least one salt is selected from the group of salts that can bind/absorb or contain crystal water. More preferred are sodium salts that can bind/contain crystal water. Most preferred are the sodium salts of citrate, silicate, and carbonate.

In the embodiment wherein a silicate salt, suitably sodium silicate, is used in the coating layer, an unexpectedly good water barrier is created that is superior compared to other salts. In the embodiment wherein a carbonate salt, suitably sodium carbonate, is used in the coating layer, the water barrier properties are less good, but surprisingly the particles remain free flowing to a high degree for a prolonged time also when water enters the particle. This is thought to be due to the fact that the water molecules adhere primarily to the coating layer and do not so much contact the GLDA in the core. Hence in a particularly preferred embodiment the coating contains sodium carbonate and/or sodium silicate.

The coating layer comprises at least one salt wherein the weight % of salt in the coating on dry basis is preferably between 70 and 99.5 wt %, more preferably between 80 and 99.5 wt %, even more preferably between 85 and 98 wt %, and most preferably between 88 and 97 wt %.

Additionally, it should be understood that the coated particles of the invention may contain other components besides the at least one salt component in the coating. Besides the embodiments wherein the coating contains other ingredients, it is also envisaged that the coating may contain two or more salts.

In a preferred embodiment, the coating in addition to the at least one salt contains at least one binder material. This embodiment where the coating contains a binder has as an advantage that it provides the coating layer with an improved strength and ensures that the coating layer is more attrition resistant. In one embodiment the binder is a polysaccharide, such as for example a cellulose ether, starch ether, guar ether, alginate, gum (e.g. xanthan gum, welan gum, diutan gum, or Arabic gum) or protein (e.g. gelatin, casein, soy protein). In a more preferred embodiment the binder is present in an amount of up to 25 wt % on the total coating layer. The binder can also be another polymer, and in a preferred embodiment a polymer that is functional as a scale inhibitor, like e.g. a polyacrylate polymer. Polymers that have scale-inhibiting properties are further described below.

In addition, the coating may be applied in two or more coating layers that may be the same or different in their composition.

When using two or more coating layers, it is preferred to have (more of) the salt in the inner layer applied on the particle/core.

In the embodiments where the coating is made of more than one layer, in yet another embodiment one of the coating layers, preferably the inner coating, may contain a compound that is functional in the end application of the particle (a “functional additive”). When the end application is in a detergent composition, the inner coating more preferably contains a scale inhibitor or another building compound/chelating agent (citrate, MGDA), a pH buffer (sodium carbonate or silicate) or a hydrophobic polymer.

It should be understood that in one embodiment the coated particles of the invention in addition to GLDA may contain another chelating agent, such as for example methylglycine N,N-diacetic acid (MGDA), ethylenediamine N,N,N′,N′-tetraacetic acid (EDTA), N-hydroxyethyl ethylenediamine N,N′,N′-triacetic acid (HEDTA), diethylenetriamine penta acetic acid (DTPA), or a salt of any of these agents. This further chelating agent may be present in the core or in the coating.

In an even more preferred embodiment, to give the inner coating salt layer an improved strength, the inner coating in addition contains a water-soluble polymer, a polysaccharide or a scale-inhibiting polymer.

In yet another embodiment an additional outer layer may be applied on the coated particles, which may comprise a flowing aid such as fumed silica.

In yet a further embodiment a subsequent coating is applied on the coated particle comprising another salt, a vinyl alcohol (co)polymer, a polysaccharide and/or a flowing aid. In a preferred embodiment the subsequent coating contains a vinyl alcohol (co)polymer.

The vinyl alcohol (co)polymer preferably is chosen from the group of partially hydrolyzed vinyl alcohol (co)polymers and their derivatives that can be modified for instance with amino groups, carboxylic acid groups and/or alkyl groups, and/or can have a degree of hydrolysis of preferably about 70 to 100 mol. %, in particular of about 80 to 99 mol. %, and/or a Höppler viscosity in 4% aqueous solution of preferably 1 to 100 mPas, in particular of about 3 to 50 mPas (measured at 20° C. in accordance with DIN 53015).

In another more preferred embodiment the subsequent coating contains a vinyl alcohol (co)polymer and a polysaccharide such as e.g. a gum (Arabic gum or xanthan gum) or a cellulose ether.

In an embodiment the particle (core) of the invention may comprise further functional additives that can be chosen from the group of scale-inhibiting additives, structurants, (co)builders, chelating agents, and pH buffers.

Preferably, if a further additive is present in the core, the core will contain a (co)builder as a further additive. In a more preferred embodiment of the present invention, the core is structured with a suitable structurant. Accordingly, the particles of the invention optionally may comprise structurants which improve the physical strength of the particle.

The (co)builder can include several salts and/or inorganic additives which contribute to the strength of the resulting particles and which also function as sequestration materials or as builders. The building salts found to be functional as a structurant for the chelating agents are citrate, carbonate, silicate, and sulfate salts. Preferably, the sodium salts of materials are used. Of these salts, sodium carbonate, sodium citrate, and sodium silicate are preferred due to their functionality (e.g. as a scale-inhibiting additive). Alternatively, inorganic (nano-) particles such as silica can be used.

In another embodiment the coating layer(s) may comprise further functional additives that can be chosen from the group of scale-inhibiting additives, structurants, (co)builders, and pH buffers.

Examples of functional additives are salts like citrate, silicate or carbonate salt, such as the alkali metal salt of any of these, that besides their above-indicated functionality have a pH buffering effect as well, or scale inhibiting polymers. Scale-inhibiting polymers can have a variety of chemical forms and are specifically selected from synthetic, natural, and hybrid scale-inhibiting polymers, preferably acrylate-based polymers. The synthetic polymer includes selected levels of carboxylation, sulfonation, phosphorylation, and hydrophobicity to give good film forming and humidity resistance as well as good co-building and crystal growth inhibition properties. The natural polymers are likewise prepared with a combination of molecular weight modification, carboxylation, sulfonation, phosphorylation, and hydrophobic properties to give good co-building and crystal growth inhibition properties. The hybrid polymers combine natural and synthetic monomers and polymers to give good co-building and crystal growth inhibition properties.

The advantage of using scale-inhibiting polymers and/or salts as a further additive is that these materials can be or are already used as co-builder or pH buffer in most of the detergent formulations and will therefore have a beneficial effect during the wash. Therefore, the current invention gives a superior product which provides other benefits such as co-building or crystal growth inhibition. Also, such particles of the present invention have excellent flow properties.

The (structured) particles have many useful functions and can be employed in many different areas, frequently connected with applications in which the chelating agent contents of the particle have to be released into the surrounding environment under controlled conditions.

The amount of GLDA in the coated particle in one embodiment is at least 30 wt %, more preferably at least 50 wt %, even more preferably at least 60 wt %, most preferably at least 90 wt %, and up to 95 wt % on the basis of the total weight of the particle.

The coated particles of the invention in one embodiment contain 15 to 90 wt % of the GLDA and optionally other chelating agents, 10 to 85 wt % of the coating, and 0 to 40 wt % of further additives. In a preferred embodiment, they contain 30 to 90 wt % of the GLDA and optionally other chelating agents, 10 to 50 wt % of the coating, and 0 to 20 wt % of further additives. Most preferably, the coated particles contain 60 to 95 wt % of GLDA and optionally other chelating agents, 5 to 20 wt % of the coating, and 0 to 20 wt % of further additives, the total amounts of ingredients adding up to 100 wt %.

Preferably, the particle comprises HnYm-GLDA, wherein m is at least 1 and n is at most 3. However, particles wherein the values of m and n are different can also be used. In such event other components in the particle or in the coating may exchange protons with the GLDA (i.e. accept therefrom or provide thereto), ensuring that effectively the desired number of hydrogen atoms are exchangeably available per GLDA anion. In a more preferred embodiment of the invention m is 1.5-3.8, most preferably m is 2.5-3.6.

The particles of the invention in one embodiment have a particle size of 200 to 2,000 microns (μm), most preferably 500-1,000 microns.

Suitable processes to apply the coating on the particle in accordance with the process of the invention are for example disclosed in the Kirk Othmer Encyclopedia of Chemical Technology, Vol 16, Microencapsulation pages 438-463 by C. Thies; John Wiley & Sons Inc. 2001)) and include, but are not limited to, the following processes:

“Fluidized-bed encapsulation technology which involves spraying shell material in solution or hot melt form onto solid particles suspended in a stream of heated gas, usually air. Although several types of fluidized-bed units exist, so-called top and bottom spray units are used most often to produce microcapsules.

In top-spray units, hot melt shell materials are sprayed onto the top of a fluidized-bed of solid particles. The coated particles are subsequently cooled producing particles with a solid shell. This technology is used to prepare a variety of encapsulated ingredients. In bottom-spray or Wurster units the coating material is sprayed as a solution into the bottom of a column of fluidized particles. The freshly coated particles are carried away from the nozzle by the airstream and up into the coating chamber where the coating solidifies due to evaporation of solvent. At the top of the column or spout, the particles settle. They ultimately fall back to the bottom of the chamber where they are guided once again by the airstream past the spray nozzle and up into the coating chamber. The cycle is repeated until a desired capsule shell thickness has been reached. Coating uniformity and final coated particle size are strongly influenced by the nozzle(s) used to apply the coating formulation. This technology is routinely used to encapsulate solids, especially pharmaceuticals (qv). It can coat a wide variety of particles, including irregularly shaped particles. The technology generally produces capsules >100-150 micrometer, but can produce coated particles <100 micrometer.”

In yet another example of a coating process, the coated particles are prepared by spraying the coating onto the particle using a fluid bed coating process as for example described by E. Teunou, D. Poncelet, “Batch and continuous fluid bed coating review and state of the art,” J. Food Eng. 53 (2002), 325-340. In the conventional fluidized bed process, the fluidized bed is a tank with a porous bottom plate. The plenum below the porous plate supplies low pressure air uniformly across the plate, leading to fluidization. The process comprises the following steps:

(a) a compound to be encapsulated in the form of a powder is fluidized with air at an air inlet temperature below the melting temperature of the powder;
(b) a coating liquid comprising a water based coating solution is sprayed onto the powder via a nozzle, followed by subsequent evaporation of the water by using elevated temperatures in the fluid bed. This leaves behind a coating layer on the particles with the compound in the core.

The process of the invention may involve an intermediate step in which a coating is applied that contains a functional additive such as a structurant, a (co)builder, and/or a pH buffer and/or a subsequent step in which a coating is applied comprising another salt, a vinyl alcohol (co)polymer, a polysaccharide and/or a flowing aid.

In a preferred embodiment, the coating applied in the subsequent step contains a vinyl alcohol (co)polymer.

In a more preferred embodiment, the vinyl alcohol (co)polymer is a partially hydrolyzed vinyl alcohol (co)polymer or a derivative thereof that can be modified for instance with amino groups, carboxylic acid groups and/or alkyl groups, and/or can have a degree of hydrolysis of about 70 to 100 mol. %, preferably of about 80 to 99 mol. %, and/or can have a Höppler viscosity in 4% aqueous solution of 1 to 100 mPas, in particular of about 3 to 50 mPas (measured at 20° C. in accordance with DIN 53015).

In another more preferred embodiment, the subsequent coating contains a vinyl alcohol (co)polymer and a polysaccharide such as e.g. a gum (Arabic gum or xanthan gum) or a cellulose ether.

The particle can be made by drying a solution of GLDA and the optional further additives.

Drying the solution can be done by any drying method known to the person skilled in the art, for instance by evaporating off the water via e.g. spray drying, fluid bed spray drying, fluid bed granulation.

The dry material may optionally be further processed, for example by compacting and/or crushing the material until it has the desired shape, i.e. is in the form of core particles of the desired size.

The step of compacting includes any method wherein the particles are agglomerated by applying an external force on them, for instance by extruding, tabletting or agglomerating them under a pressure of suitably from 40 to 200 MPa, preferably a pressure of from 50 to 120 MPa, most preferably of from 75 to 100 MPa.

The pressure used for compacting the material is the pressure applied at uniaxial compaction of a tablet (leading to a certain density of the compacted particle mixture). However, compacting may suitably be done by other compactors, like a roll compactor. In such cases, the pressure to be used is the pressure that results in the same density of the compact as in uniaxial compaction.

The step of crushing includes any method whereby the size of the particles is decreased and is intended to include methods like breaking, crushing, or milling.

In another more preferred embodiment of the process of the invention, the coating mixture layer is applied on the material containing the chelating agent at a pH of 2-11, more preferably 5-10, most preferably 7-10.

In a preferred embodiment of the invention, the process to prepare the coated particles encompasses the preparation of a granule (particle) that is subsequently coated in a fluid bed coating process. The granule preparation is started by dissolving the chelating agent in water together with the coating material and if required a structurant. This mixture is sprayed into a hot spray drying chamber, leading to the evaporation of water. The particles formed this way are recirculated in the spray chamber and at the same time spraying the water based mixture into the chamber is continued, due to which the particle grows and a granule is gradually formed. The composition gradient inside the granule can be modified by altering the composition of the spray mix while spraying it into the drying chamber. This means that the core of the particle can be higher in concentration of the compound, whereas the outer part of the particle is enriched with the coating material. The particle formed is described as a co-granule, as it consists of the compound, the coating material, and if required a structurant. The obtained co-granule is subsequently coated in a fluid bed process. In this process, a powder is fluidized with warm air and a water based coating solution is sprayed onto the powder. The water is evaporated, leaving a coating on the particle surface. The amount of coating can be controlled easily by manipulating the spray on time.

### EXAMPLES

In all examples co-granules of GLDA and Alcoguard 4160 or granules consisting of GLDA only are used. Below the processes to manufacture those (co-)granules are described. These (co-)granules are subsequently coated with a water-soluble salt. The process to achieve such a coating is also described below. The resulting coated particles are stored in a climate chamber to follow the moisture absorption over time in order to determine the efficiency of the coating system used. The test method is described below.

### Processes Used

### Manufacture of GLDA (Co)Granule

Co-granules of GLDA and Alcoguard 4160 were produced in a spray granulation process. The co-granules were made on the basis of GLDA (Dissolvine GL-47-S and Dissolvine GL-Na-36-S available from Akzo Nobel Functional Chemicals LLC, Chicago, Ill., USA) and the anti-scaling polymer Alcoguard 4160 (available as a dissolved polymer solution or in dry form from Akzo Nobel Surface Chemistry LLC, Chicago, Ill., USA).

To produce the co-granule, GL47S and GL-Na-36-S mixed in ratio of 95:5 were mixed with Alcoguard 4160 (also abbreviated as “4160”), where the ratio of the total amounts of GLDA and Alcoguard 4160 was 80:20 or 85:15. This mixture was sprayed into a hot spray drying chamber, leading to the evaporation of water. The particles formed this way were recirculated into the spray chamber via cyclones and at the same time spraying the water based GLDA/4160 mixture into the chamber was continued, due to which the particle grew and a granule was gradually formed. More specifically, the mixture of GLDA and 4160 was continuously sprayed into a fluid bed spray granulator type AGT, equipped with cyclones, an external filter unit, and a scrubber. During the spray granulation process, the air flow was kept between 700-1300 m³/hour and air inlet temperatures between 100 and 250° C. were used. The particle formed is described as a co-granule, as it consisted of GLDA and the anti-scaling polymer. This process resulted in a free flowing powder, described as “uncoated” co-granule.

To produce the GLDA-pure granule, the same process as described for the co-granule was used, except that in this case the spray mix consisted of GL47S and GL-Na-36S mixed in ratio of 85:15, hence no anti-scaling polymer was used.

### Manufacture of Coated Particles

The “uncoated” GLDA/4160 co-granule or GLDA-pure granule was subsequently coated in a fluid bed (GEA Aeromatic Strea-1) using a Wurster set-up and a two-fluid nozzle. The Wurster set-up is a draft tube positioned in the centre of the fluid bed, below which a nozzle is positioned that sprays fine droplets upwards into the tube. These droplets hit the granule surface and after drying leave behind some dry coating material. Using this set-up an even coating can be applied. The air inlet temperature used was 80-90° C. The air flow was chosen such that visually an even fluidization was obtained, which implies a setting between 10 and 80% of the maximum air flow on the GEA Aeromatic Strea-1. The spray-on rate of the coating solution was chosen such that an even coating was obtained on the particles giving no particle aggregation (i.e. about 0.5-1 gram/minute), resulting in a particle coated with an even coating layer. Coating was continued until a predefined amount of coating was obtained on the particles.

For some coated particles, a Glatt laboratory fluid bed was used. In this equipment air inlet temperatures were varied between 80 and 150° C. and where not specified in the Examples below, a temperature of about 100° C. was used. Spraying of the liquid was done via top spray using a twin fluid air assisted nozzle. Again, the spray rate was chosen such that aggregation was avoided and an even coating was obtained.

### Moisture Absorption

The resulting powders were poured in a 1-particle thick layer onto a petri dish and stored in a climate chamber operated at 16° C. and 60% Relative Humidity. The weight increase as a function of time was measured, as a measure for the rate of absorption of moisture. The weight increase was recomputed into a % weight increase by using the following formula:

Weight % increase at time t=[Weight (at t=0)−Weight (at time t)]/[Weight (at t=0)].

### Example 1

### Sodium Carbonate as Moisture Barrier on GLDA Co-Granule

Granules were made on the basis of GLDA (Dissolvine GL-47-S and Dissolvine GL-Na-36-S, anti-scaling polymer Alcoguard 4160, the functional salt sodium carbonate anhydrous (laboratory grade, ex J. T. Baker), and Arabic gum (laboratory grade, ex Acros Organics).

First co-granules of GLDA and Alcoguard 4160 were produced in a spray granulation process using the same process as described before. The weight ratio of total GLDA to Alcoguard 4160 was 85:15. The “uncoated” GLDA/4160 co-granule was subsequently coated with a mixture of sodium carbonate and Arabic gum in a Glatt lab scale fluid bed, wherein the weight ratio carbonate/gum was 97:3.

The results for the moisture uptake are shown below. A layer of sodium carbonate was found to give a reduction in moisture uptake, even though sodium carbonate absorbs moisture itself, implying that the moisture uptake of the core was even lower. A higher level of sodium carbonate gives more barrier properties and therefore a slower moisture uptake.

TABLE 1
Results for moisture uptake.

| | GLDA/4160 | GLDA/4160 | GLDA/4160 |
|---|---|---|---|
| | [85:15] | [85:15] + | [85:15] + |
| dT | uncoated | 10% Na2CO3 | 30% Na2CO3 |
| [hrs] | wt % water | wt % water | wt % water |
| 0 | 0.00 | 0.00 | 0.00 |
| 1 | 9.67 | 5.81 | 1.57 |
| 2.25 | 17.00 | 10.97 | 3.08 |
| 3 | 20.74 | 14.16 | 3.98 |
| 5 | 27.39 | 21.10 | 6.36 |
| 7 | 31.50 | 26.45 | 8.58 |
| 23 | 46.83 | 47.20 | 22.81 |

### Example 2

### Sodium Carbonate as Moisture Barrier on Pure GLDA Granule

Granules were made on the basis of GLDA (Dissolvine GL-47-S and Dissolvine GL-Na-36-S, the functional salt (in dish washing) sodium carbonate anhydrous (laboratory grade, ex J. T. Baker), and Arabic gum (laboratory grade, ex Acros Organics).

First a granule of pure GLDA was produced in a spray granulation process using the process as described before. The “uncoated” GLDA-pure granule was subsequently coated with a mixture of sodium carbonate and Arabic gum in a ratio of about 80:20 in a fluid bed (GEA Aeromatic Strea-1). This coating was continued until about 14 wt % of a coating layer was applied onto the granule (wherein 11% was sodium carbonate and 3% Arabic gum).

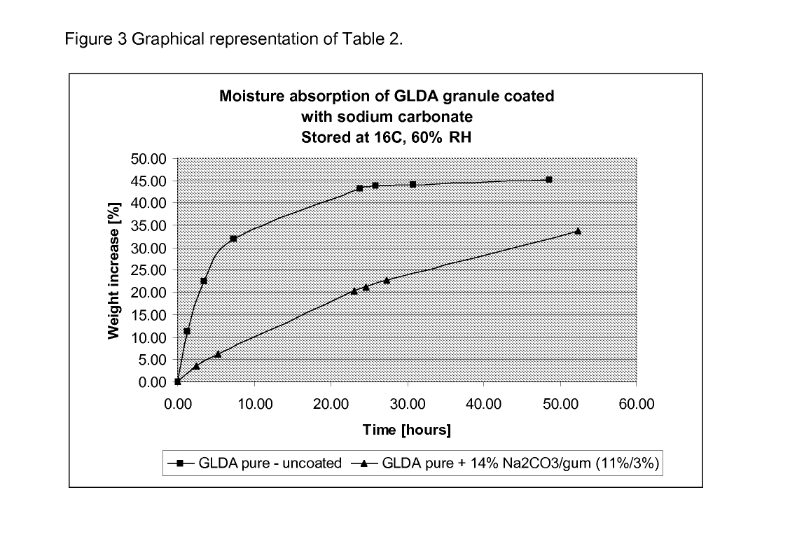

Table 2 and FIG. 3 show that the layer of sodium carbonate with Arabic gum gives a delayed moisture uptake compared to the uncoated granule.

TABLE 2
Results of moisture absorption

| | GLDA pure - | | GLDA pure + |
|---|---|---|---|
| Time | uncoated | Time | 14% Na2CO3/gum |
| [hrs] | wt % water | [hrs] | wt % water |
| 0.00 | 0.00 | 0.00 | 0.00 |
| 1.33 | 11.18 | 2.50 | 3.55 |
| 3.50 | 22.36 | 5.25 | 6.17 |
| 7.33 | 31.98 | 23.08 | 20.32 |
| 23.92 | 43.10 | 24.58 | 21.12 |
| 25.92 | 43.94 | 27.33 | 22.69 |
| 30.83 | 44.13 | 52.42 | 33.67 |
| 48.67 | 45.16 | | |

### Example 3

### Citrate as Coating Layer

Granules were made on the basis of GLDA (Dissolvine GL-47-S and Dissolvine GL-Na-36-S, anti-scaling polymer Alcoguard 4160, the functional salt tri-sodium citrate (laboratory grade, ex Fisher Scientific), and xanthan gum (laboratory grade, ex Aldrich).

First co-granules of GLDA and Alcoguard 4160 were produced in a spray granulation process using the same process as described before. The “uncoated” GLDA/4160 co-granule was subsequently coated with a mixture of citrate and xanthan gum in a fluid bed (GEA Aeromatic Strea-1). This was done using a solution in water with 13% tri-sodium citrate and about 0.2% xanthan gum. This solution was coated onto the co-granules, using a Würster set-up and a two-fluid nozzle, until about 16 wt % citrate and 0.27% xanthan gum (the wt % based on the total particle) was coated onto the co-granule. The air inlet temperature used was 80° C.

The results of the moisture absorption measurements are given in Table 3 below. This table shows that using a citrate/xantham gum layer as an outer coating gives a reduction in the rate of moisture absorption.

TABLE 3
Results of water absorption

| | | | co-granule + |
|---|---|---|---|
| | co-granule | | 16% citrate/ |
| dT | uncoated | dT | 0.3% Xantan Gum |
| [hrs] | wt % water | [hrs] | wt % water |
| 0.00 | 0.0 | 0.00 | 0.0 |
| 1.00 | 11.2 | 1.08 | 5.9 |
| 3.67 | 26.7 | 3.17 | 14.9 |
| 6.00 | 33.0 | | |
| 7.50 | 36.0 | 7.33 | 26.1 |
| 23.25 | 45.8 | 23.92 | 37.6 |
| 25.25 | 45.9 | | |
| 27.58 | 46.2 | 27.33 | 38.2 |
| 31.83 | 46.2 | 31.08 | 38.6 |
| 49.83 | 45.7 | 49.42 | 39.5 |

### Example 4

### Citrate/Arabic Gum as Coating Layer

Granules were made on the basis of GLDA (Dissolvine GL-47-S and Dissolvine GL-Na-36-S, anti-scaling polymer Alcoguard 4160, the functional salt tri-sodium citrate (laboratory grade, ex Fisher Scientific, and Arabic gum (laboratory grade, ex Aldrich).

First co-granules of GLDA and Alcoguard 4160 were produced in a spray granulation process using the same process as described before. The weight ratio of total GLDA to Alcoguard 4160 in this case was 80:20. The “uncoated” GLDA/4160 co-granule was subsequently coated with 10 weight % of a mixture of citrate and Arabic gum, using a weight ratio of citrate:Arabic gum of 99:1, in a fluid bed (Glatt).

Table 4 shows the results of the moisture uptake and it can be seen that the citrate/Arabic gum layer gives a reduced rate of moisture uptake.

TABLE 4
Results of moisture uptake.

| | | | co-granule + |
|---|---|---|---|
| | co-granule | | 10% citrate/ |
| Time | uncoated | Time | Arabic gum [99:1] |
| [hrs] | wt % water | [hrs] | wt % water |
| 0.00 | 0.00 | 0.00 | 0.00 |
| 1.00 | 11.24 | 1.00 | 1.61 |
| 3.67 | 26.72 | 3.00 | 4.24 |
| 6.00 | 33.00 | 5.00 | 6.55 |
| 7.50 | 36.04 | 6.00 | 7.58 |
| 23.25 | 45.83 | 23.58 | 23.65 |
| 25.25 | 45.90 | 27.25 | 26.02 |
| 27.58 | 46.16 | 30.50 | 27.77 |
| 31.83 | 46.23 | 48 | 32.97 |
| 49.83 | 45.70 | | |

### Example 5

### Sodium Silicate as Coating Layer

Granules were made on the basis of GLDA (Dissolvine GL-47-S and Dissolvine GL-Na-36-S), the anti-scaling polymer Alcoguard 4160, sodium silicate 50/52 (ex Woellner, Germany)

First co-granules of GLDA and Alcoguard 4160 (in a ratio of 85:15) were produced in a spray granulation process using the same process as described before.

The “uncoated” GLDA/4160 co-granule was subsequently coated with the sodium silicate in a Glatt fluid bed coater until 20 wt % or 30 wt % was applied. The solutions were all coated onto the co-granules, using the Glatt lab scale fluid bed using an air temperature of 100-140° C.

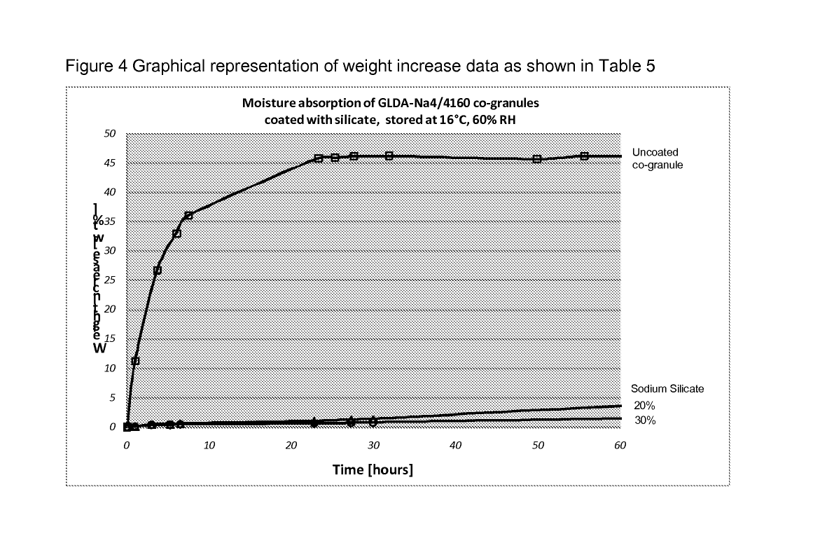

Moisture absorption of these powders was determined as described above. The results of those tests are shown in Table 5 below and FIG. 4, together with the data of the uncoated co-granule.

TABLE 5
Results of moisture absorption

| | Uncoated | | 20% | 30% |
|---|---|---|---|---|
| dT | co-granule | dT | Silicate | Silicate |
| [hrs] | wt % water | [hrs] | wt % water | wt % water |
| 0.00 | 0.00 | 0.00 | 0.00 | 0.00 |
| 1.00 | 11.24 | 1.00 | 0.07 | 0.06 |
| 3.67 | 26.72 | 3.00 | 0.39 | 0.29 |
| 6.00 | 33.00 | 5.25 | 0.40 | 0.35 |
| 7.50 | 36.04 | 6.50 | 0.52 | 0.42 |
| 23.25 | 45.83 | 22.75 | 0.98 | 0.58 |
| 25.25 | 45.90 | 27.25 | 1.25 | 0.66 |
| 27.58 | 46.16 | 29.92 | 1.33 | 0.75 |
| 31.83 | 46.23 | 95.33 | 6.14 | 2.19 |
| 49.83 | 45.70 | | | |
| 55.58 | 46.16 | | | |
| 75.17 | 46.36 | | | |

### Example 6

### Sodium Silicate as Moisture Barrier on GLDA Co-Granule

Granules were made on the basis of GLDA (Dissolvine GL-47-S and Dissolvine GL-Na-36-S, anti-scaling polymer Alcoguard 4160, the functional salt sodium silicate Crystal0265 (ex PQ Silica).

First co-granules of GLDA and Alcoguard 4160 were produced in a spray granulation process using the same process as described before. The “uncoated” GLDA/4160 co-granule was subsequently coated with sodium silicate in a Glatt lab scale fluid bed using a powder temperature of about 100° C.

The results of the moisture uptake test are shown below.

TABLE 6
Results of moisture absorption test

| | | | GLDA/4160 | GLDA/4160 |
|---|---|---|---|---|
| | GLDA/4160 | | [85:15] + 10% | [85:15] + 30% |
| | [85:15] | | sodium Silicate | Sodium Silicate |
| dT | uncoated | dT | Crystal 0265 | Crystal 0265 |
| [hrs] | wt % water | [hrs] | wt % water | wt % water |
| 0.00 | 0.00 | 0.00 | 0.0 | 0.0 |
| 1.00 | 5.62 | 1.08 | 0.9 | 0.6 |
| 3.67 | 12.53 | 3.00 | 1.7 | 0.5 |
| 5.50 | 16.45 | 5.25 | 2.6 | 0.6 |
| 7.50 | 19.27 | 21.08 | 8.4 | 1.1 |
| 26.08 | 37.31 | 27.25 | 10.9 | 1.6 |
| 31.25 | 40.31 | | | |

Table 6 shows that a layer of sodium silicate gives a significant reduction in moisture uptake for the GLDA co-granule. The higher the silicate content, the slower the moisture uptake.

### Example 7

### Free Flowability of Particles

Three coated GLDA samples were prepared according to the procedure described above using a fluid bed coating process. The samples were coated with 30% sodium carbonate, 30% sodium silicate, and 15% PVOH/Arabic gum, respectively. All samples were stored in a petri dish in a controlled environment at 16° C., 60% RH and at 27° C., 60% RH. The moisture uptake and flowability were followed over time. The time at which the samples lost their flowability was defined as the time at which less than 80% of the granules still moved freely in the petri dish. As this is sometimes difficult to determine exactly, a time span was defined in some cases. The results for the three coated systems are given below in Tables 7-9

TABLE 7
Water uptake and free flowability for sodium carbonate

| 30% soda coating | | |
|---|---|---|
| | 16 C., 60% RH | 27 C., 60% RH |

| | | | | |
|---|---|---|---|---|
| Time to lose | 12-24 | hours | <2 | hours |
| flowiness | | | | |
| Weight increase | ~12-20 | wt % | ~1 | wt % |
| at that time | | | | |

The above results indicate that at a storage condition of 16° C., 60% RH, the moisture uptake at the time flow properties were lost was much higher than at 27° C., 60% RH. In the latter case flow properties were lost much faster, even though the moisture uptake was far less. Without being bound by any theory, it is hypothesized that at the higher temperature, the GLDA obtains a lower viscosity and therefore bleeds out of the granule faster, making it losing its flowability faster. This shows that there is no direct relationship between moisture uptake and flowability.

TABLE 8
Water uptake and free flowability for sodium silicate

| 30% sodium silicate coating | | |
|---|---|---|
| | 16 C., 60% RH | 27 C., 60% RH |

| | | | | |
|---|---|---|---|---|
| Time to lose | 12-24 | hours | <1 | hours |
| flowiness | | | | |
| Weight increase | ~3.5 | wt % | ~0.5 | wt % |
| at that time | | | | |

These results indicate a similar effect to the one seen with the soda coating. Again, moisture uptake is higher at a lower temperature at the time flowability is lost, when comparing it to the higher temperature condition.

TABLE 9
Water uptake and free flowability for PvOH/AG

| 15% PVOH/Arabic gum | | |
|---|---|---|
| | 16 C., 60% RH | 27 C., 60% RH |

| | | | | |
|---|---|---|---|---|
| Time to lose | ~24 | hours | ~12 | hours |
| flowiness | | | | |
| Weight increase | ~4 | wt % | ~7 | wt % |
| at that time | | | | |

In contradiction to the results shown above for salt-based coatings, these results suggest that with a PVOH/Arabic gum coating, an increased moisture uptake correlates to a reduction of flowability.

All the results combined above indicate that there is no evident correlation between the flowability of coated GLDA granules and the moisture uptake. This suggests that to obtain a free flowing coated GLDA powder it is not just a matter of finding a coating that lowers the moisture uptake as such, but also about how well the coating retains the GLDA inside the coated granules. Hence a coating needs to balance two physical processes: water uptake and GLDA diffusion.

1. Coated particle containing a particle and a coating, wherein the particle contains glutamic acid N,N-diacetic acid or a partial salt thereof of the formula HnYm-GLDA, wherein Y is a cation, selected from the group consisting of sodium, potassium, and mixtures thereof, n+m=4, and wherein the coating contains at least one salt that contains as a cation at least one of sodium, potassium or lithium and as anion at least one of silicate and carbonate.

2. Coated particle of claim 1 wherein the salt is selected from the group consisting of salts that can absorb and/or bind crystal water.

3. Coated particle of claim 1 wherein the coating forms a closed layer, as can be established by Scanning Electron Microscopy/EDX.

4. Coated particle of claim 1 wherein the coating in addition contains a binder.

5. Coated particle of claim 1 wherein in the coating the weight % of the salt on dry basis is between 70 and 99.5 wt %

6. Coated particle of claim 1 comprising two or more coating layers that may be the same or different.

7. Coated particle of claim 1 containing an additional coating layer comprising at least one vinyl alcohol (co)polymer.

8. Coated particle of claim 1 additionally comprising additives selected from the group consisting of scale-inhibiting additives, structurants, (co)builders, pH buffers, chelating agents, flowing aids, and nanoparticles.

9. Coated particle of claim 1 wherein m is at least 1 and n is at most 3, n+m=4, and Y is a cation selected from the group consisting of sodium, potassium, and mixtures thereof.

10. Coated particle of claim 1 wherein the coating contains sodium silicate and/or sodium carbonate.

11. Process to prepare coated particles containing a particle and a coating, wherein the particle contains glutamic acid N,N-diacetic acid or a partial salt thereof of the formula HnYm-GLDA, wherein Y is a cation that is sodium, potassium or a mixture thereof, n+m=4, and the coating comprises at least one salt that contains as a cation at least one of sodium, potassium or lithium and as anion at least one of silicate and carbonate.

12. Process of claim 11, containing an intermediate step in which a coating is applied that may contain a structurant, a (co)builder and/or a pH buffer and/or a subsequent step in which a coating is applied comprising another salt, a vinyl alcohol (co)polymer, a polysaccharide and/or a flowing aid.

13. A detergent composition, agricultural composition, an oil field composition or a water treatment composition comprising the coated particle of claim 1.
